(19) United States
(12) Patent Application Publication
(10) Pub. No.: US 2011/0201757 A1
(43) Pub. Date: Aug. 18, 2011

(54) Methods for Production of High Impact Polystyrene

(75) Inventors: Jose M. Sosa, Deer Park, TX (US); Shazia Ullah, Houston, TX (US); Billy Ellis, Georgetown, TX (US)

(73) Assignee: FINA TECHNOLOGY, Inc., Houston, TX (US)

(21) Appl. No.: 13/093,160

(22) Filed: Apr. 25, 2011

Related U.S. Application Data
(63) Continuation of application No. 11/425,618, filed on Jun. 21, 2006, now abandoned.

(51) Int. Cl. C08L 9/06

(52) U.S. Cl. 525/232

(57) ABSTRACT

A method of preparing a high impact polystyrene comprising contacting styrene monomer, a high cis polybutadiene elastomer, and an initiator under high shear within a reaction zone. A high-impact polystyrene comprising a high cis polybutadiene elastomer. A method of preparing a high impact polystyrene comprising contacting styrene monomer, a high cis polybutadiene elastomer, and an initiator under extreme reaction conditions within a reaction zone.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to the production of high-impact polystyrene and more specifically to the production of high-impact polystyrene having a specified morphology.

2. Background of the Invention

Elastomer-reinforced polymers of monovinylidene aromatic compounds such as styrene, alpha-methylstyrene and ring-substituted styrene have found widespread commercial use. For example, elastomer-reinforced styrene polymers having discrete particles of cross-linked elastomer dispersed throughout the styrene polymer matrix can be useful for a range of applications including food packaging, office supplies, point-of-purchase signs and displays, housewares and consumer goods, building insulation and cosmetics packaging. Such elastomer-reinforced polymers are commonly referred to as high impact polystyrene (HIPS).

Methods for the production of polymers, such as HIPS, typically employ polymerization using a continuous flow process. Due to the highly exothermic nature of polymerization reactions, high rate production of HIPS may involve extreme reaction conditions such as high temperature and high shear rates. Although necessary for the efficient manufacturing of HIPS, such extreme reaction conditions may result in the HIPS having an undesirable mixed morphological structure. This undesirable mixed morphology may be further characterized by a wide elastomer particle size distribution with the HIPS having a significant level of small elastomer particles with mean diameters of less than 1 micron. Small elastomer particles with mixed morphologies such as thread or maze morphologies may lead to poor elastomer utilization. Furthermore, while HIPS with morphologies characterized by the presence of small elastomer particles tend to have favorable impact properties such as a high Izod impact value, they generally exhibit poor ductile properties with low values for the percent elongation at fail. Thus a need exists for a method of producing HIPS with improved morphologies. Furthermore, there exists a need for a method of producing HIPS with a narrow elastomer particle size distribution under extreme reaction conditions.

### BRIEF SUMMARY OF SOME OF THE EMBODIMENTS

Disclosed herein is a method of preparing a high impact polystyrene comprising contacting styrene monomer, a high cis polybutadiene elastomer, and an initiator under high shear within a reaction zone.

Also disclosed herein is a high-impact polystyrene comprising a high cis polybutadiene elastomer.

Further disclosed herein is a method of preparing a high impact polystyrene comprising contacting styrene monomer, a high cis polybutadiene elastomer, and an initiator under extreme reaction conditions within a reaction zone.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the embodiments of the invention, reference will now be made to the accompanying drawings in which:

FIG. 1 is an illustration of the HIPS polymerization reaction.

FIG. 2 is a plot of percent solids as a function of time for samples described in Example 1.

FIG. 3 is a plot of elastomer particle size and elastomer particle size distribution as a function of solution viscosity for the samples described in Example 1.

FIG. 4 is a plot of the weight average molecular weight as a function of solution viscosity for the samples described in Example 1.

FIGS. 5-8 are transmission electron micrographs of HIPS produced with low cis elastomers.

FIGS. 9-10 are transmission electron micrographs of HIPS produced with high cis elastomers.

### DETAILED DESCRIPTION OF THE EMBODIMENTS

Disclosed herein is a method for the production of HIPS comprising the incorporation of high-cis elastomers. The method may further comprise the production of said HIPS under conditions that are termed herein extreme reaction conditions. Such extreme reaction conditions may include high production rates, high temperatures, high shear and combinations thereof. Herein high shear refers the process of agitation as may be brought about through the use of a variety of equipment and procedures as known to one of ordinary skill in the art. As used herein, high shear refers to the shear rate which will be described in more detail later herein.

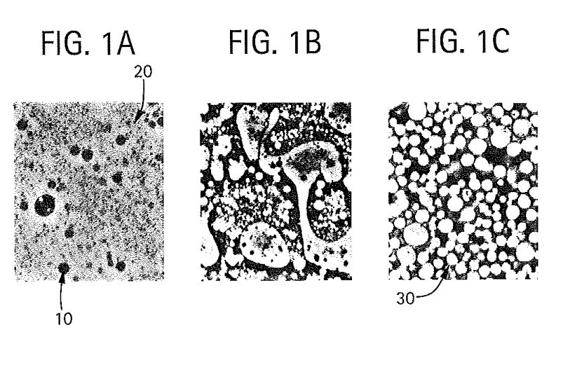

In an embodiment, a method for the production of HIPS comprises the dissolution of polybutadiene elastomer (PB) in styrene that is subsequently polymerized. During polymerization, a phase separation based on the immiscibility of polystyrene (PS) and polybutadiene (PB) occurs in two stages. Initially, the PB forms the major or continuous phase with styrene dispersed therein. As the reaction begins, PS droplets 10 (darker circles) form and are dispersed in an elastomer solution 20 (lighter background) of PB and styrene monomer, as shown in FIG. 1A. As the reaction progresses and the amount of polystyrene continues to increase, a morphological transformation or phase inversion occurs such that the PS now forms the continuous phase and the PB and styrene monomer forms the discontinuous phase, as shown in FIG. 1B. This phase inversion leads to the formation of the discontinuous phase comprising complex elastomeric particles in which the elastomer exists in the form of PB membranes surrounding occluded domains of PS, as indicated by reference numeral 30 (lighter circles) in FIG. 1C. Shear agitation is thought to be necessary in order to cause the phase inversion. Polymerizations carried out in a rheometer have shown that a shear rate of 10-30 sec⁻¹ is sufficient to invert the two phases.

HIPS polymerization may be represented according to the chemical equations given below:

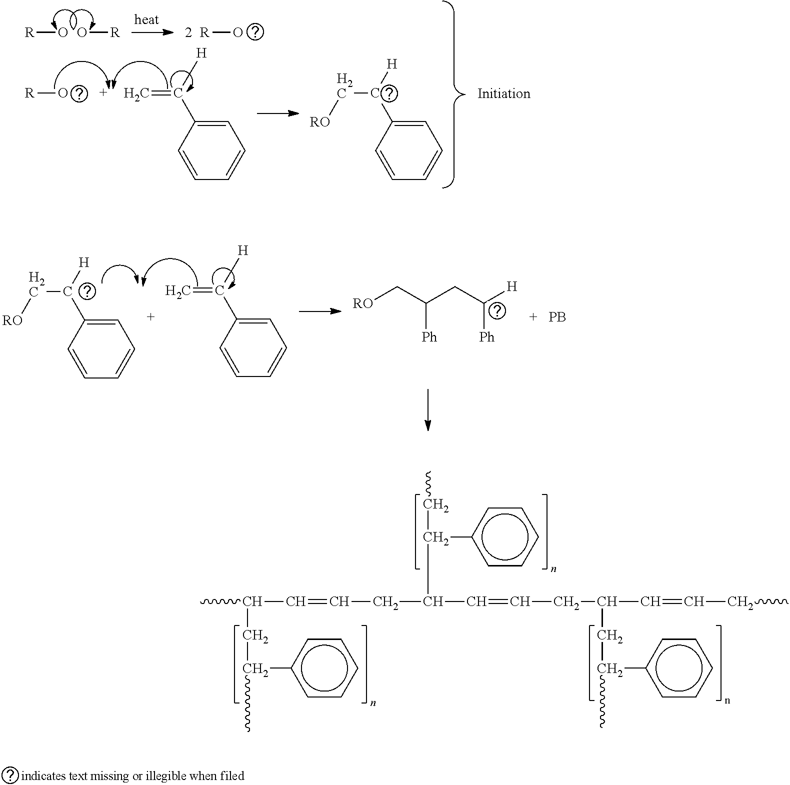

The reaction depicts the formation of polystyrene chains in the presence of PB leading to the production of a grafted polybutadiene PS, which is essential in forming the morphology of HIPS. These reactions, also termed grafting reactions, are favored by high levels of initiators and high temperatures. The grafted PB-PS polymers (e.g., HIPS) may function as emulsifiers and develop different morphologies as will be described in detail later herein. Without wishing to be limited by theory, it is thought that the grafting of PB onto PS occurs predominantly through hydrogen abstraction to yield allylic radicals. The typical cis elastomers used for HIPS production comprise from 10% to 12% vinyl groups. These elastomers tend to graft more readily than those having nearly 99% cis or high-cis structures.

The polymerization of the styrene monomer can be done using any method known to be useful to those of ordinary skill in the art for preparing HIPS. Said reactions may be carried out using a continuous production process in a polymerization apparatus comprising a single reactor or a plurality of reactors. For example, the HIPS can be prepared using an upflow reactor. The polymerization process can be either batch or continuous.

The temperature ranges useful with the process of the present disclosure can be selected to be consistent with the operational characteristics of the equipment used to perform the polymerization. In one embodiment, the temperature range for the polymerization can be from 100° C. to 230° C. In another embodiment, the temperature range for the polymerization can be from 110° C. to 180° C. In yet another embodiment, the HIPS polymerization reaction may be carried out in a plurality of reactors with each reactor having an optimum temperature range. For example, the HIPS polymerization reaction may be carried out in a reactor system employing a first and a second polymerization reactor that are continuously stirred tank reactors (CSTR). In one embodiment, the first CSTR may be operated in the temperature range of from 110° C. to 135° C. while the second CSTR may be operated in the range of from 135° C. to 165° C.

In an embodiment, HIPS polymerization is carried out at a high production rate. Herein a high production or conversion rate refers to a production of HIPS at a rate of greater than 8% PS/hr, alternatively greater than about 12% PS/hr, alternatively greater than about 16% PS/hr at from 55 parts to 100 parts per hundred styrene in the reaction mixture. Above a rate of 20-25% PS/hr the reactions become uncontrollable at a styrene concentration of 55 to 100 parts of the mixture. As is known to one of ordinary skill in the art, the HIPS polymerization reaction is exothermic resulting in a high reaction temperature that may be mitigated through the use of good mixing. Agitators that produce good mixing through turbulence are often used. Such agitators can produce high shear rates that affect the morphology of the elastomer particles that are formed. Herein a high temperature refers to a temperature of greater than 165° C., alternatively greater than about 175° C., alternatively greater than about 185° C., while a high shear rate refers to agitation at a rate of from 50 s⁻¹ to 500 s⁻¹, alternatively from 50 s⁻¹ to 450 s⁻¹, alternatively from 50 s⁻¹ to 400 s⁻¹. Herein extreme reaction conditions are defined as any combination of high reaction temperature, high production rate and high shear rate.

In an embodiment, the HIPS comprises an elastomer, alternatively polybutadiene, alternatively a high-cis polybutadiene (HCP). Herein the designation cis refers to the stereoconfiguration of the individual butadiene monomers wherein the main polymer chain is on the same side of the carbon-carbon double bond contained in the polybutadiene backbone as is shown in Structure I:

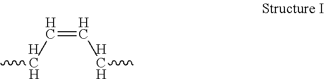

In an embodiment, a HCP for use in this disclosure has greater than 90% cis content, alternatively greater than 95% cis content, alternatively greater than 99% cis content wherein the cis content is measured by infrared spectroscopy or nuclear magnetic resonance as known to one of ordinary skill in the art.

The HCPs of this disclosure may be further characterized by a low vinyl content. Herein a low vinyl content refers to a less than 5% of the material having terminal double bonds of the type represented in Structure II:

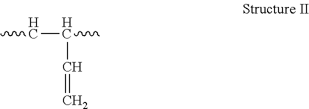

Such HCPs may be prepared by any means known to one of ordinary skill in the art for the preparation of an HCP. For example, the HCP may be prepared through a solution process using a transition metal or alkyl metal catalyst.

Examples of HCPs suitable for use in this disclosure include without limitation BUNA CB KA 8967 or 8969 butadiene elastomers, which are high cis polybutadiene elastomers commercially available from Lanxess Corporation. In an embodiment, a HCP for use in this disclosure (e.g. BUNA CB KA 8967 or BUNA CB KA 8969) has generally the physical properties given in Table 1a or 1b.

TABLE 1a

| | | | |
|---|---|---|---|
| PROPERTY | Min. | Max | Test Method |

Raw Polymer Properties

| | | | |
|---|---|---|---|
| Mooney Viscosity | 58 | 68 | DIN 53 523 |
| UML 1 + 4 (100° C.) | | | |
| (MU) | | | |
| Volatile matter (wt %) | | 0.5 | ASTM D 5668 |
| Total ash (wt %) | | 0.5 | ASTM D 5667 |
| Organic acid (5) | | 1.0 | ASTM D 5774 |

Cure Characteristics⁽¹⁾⁽²⁾

| | | | |
|---|---|---|---|
| Minimum torque (dN, m) | 4.3 | 6.3 | ISO 6502 |
| Maximum Torque, | 19.9 | 25.3 | ISO 6502 |
| S′ max. (dN, m) | | | |
| tₛ1 (min) | 2.1 | 3.1 | ISO 6502 |
| t′50 (min) | 6.6 | 9.8 | ISO 6502 |

| Other Product Features | Typical Value |
|---|---|
| Cis 1,4-content | 96 |
| Specific Gravity | 0.91 |
| Stabilizer Type | Non-staining |

⁽¹⁾Monsanto Rheometer, MDR at 160° C., 30 min., ±0.5 degree arc
⁽²⁾Cure characteristics determined on formulation according to ISO 2476

TABLE 1b

| | | | |
|---|---|---|---|
| PROPERTY | Min. | Max | Test Method |

Raw Polymer Properties

| | | | |
|---|---|---|---|
| Mooney Viscosity | 39 | 49 | DIN 53 523 |
| UML 1 + 4 (100° C.) | | | |
| (MU) | | | |
| Volatile matter (wt %) | | 0.5 | ASTM D 5668 |
| Total ash (wt %) | | 0.5 | ASTM D 5667 |
| Organic acid (5) | | 1.0 | ASTM D 5774 |

Cure Characteristics⁽¹⁾⁽²⁾

| | | | |
|---|---|---|---|
| Minimum torque (dN, m) | 2.3 | 3.3 | ISO 6502 |
| Maximum Torque, | 16.7 | 21.3 | ISO 6502 |
| S′ max. (dN, m) | | | |
| tₛ1 (min) | 2.2 | 3.2 | ISO 6502 |
| t′50 (min) | 5.9 | 8.7 | ISO 6502 |

| Other Product Features | Typical Value |
|---|---|
| Cis 1,4-content | 96 |
| Specific Gravity | 0.91 |
| Stabilizer Type | Non-staining |

⁽¹⁾Monsanto Rheometer, MDR at 160° C., 30 min., ±0.5 degree arc
⁽²⁾Cure characteristics determined on formulation according to ISO 2476

In an embodiment, the HCP is present in the reaction mixture in an amount of from 1 wt. % to 15 wt. %, alternatively from 3 wt. % to 10 wt. %, and alternatively from 4 wt. % to 8 wt. % based on total composition of the feed solution.

In an embodiment, the HIPS comprises a polymer of styrene. Styrene, also known as vinyl benzene, ethylenylbenzene and phenylethene is an organic compound represented by the chemical formula C₈H₈. Styrene is widely commercially available and as used herein the term styrene includes a variety of substituted styrenes (e.g., alpha-methyl styrene), ring-substituted styrenes such as p-methylstyrene as well as unsubstituted styrenes.

In an embodiment, the HIPS reaction contains at least one initiator. Such initiators may function as the source of free radicals to enable the polymerization of styrene. In an embodiment, any initiator capable of free radical formation that facilitates the polymerization of styrene may be employed. Such initiators are well known in the art and include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides or combinations thereof. In an embodiment, the initiator level in the reaction is given in terms of the active oxygen in parts per million (ppm). In an embodiment, the level of active oxygen level in the disclosed reactions for the production of HIPS is from 20 ppm to 80 ppm, alternatively from 20 ppm to 60 ppm, alternatively from 30 ppm to 60 ppm. As will be understood by one of ordinary skill in the art, the selection of initiator and effective amount will depend on numerous factors (e.g. temperature, reaction time) and can be chosen by one skilled in the art to meet the desired needs of the process.

In an embodiment, the HIPS may also contain additives as deemed necessary to impart desired physical properties, such as, increased gloss or color. Examples of additives include without limitation chain transfer agents, talc, antioxidants, UV stabilizers, lubricants, mineral oil, plasticizers and the like. The aforementioned additives may be used either singularly or in combination to form various formulations of the HIPS. For example, stabilizers or stabilization agents may be employed to help protect the HIPS from degradation due to exposure to excessive temperatures and/or ultraviolet light. These additives may be included in amounts effective to impart the desired properties. Effective additive amounts and processes for inclusion of these additives to polymeric compositions are known to one skilled in the art.

In an embodiment, a reaction mixture for the production of HIPS may comprise from 75% to 99% styrene, from 1% to 15% HCP, from 0.001% to 0.2% initiator and additional components as needed to impart the desired physical properties. The percent values given are percentages by weight of the total composition.

In an embodiment, the HIPS of this disclosure has PS with a weight average molecular weight, as measured against a polystyrene standard, of from 120,000 to 350,000 Daltons, alternatively from 150,000 to 300,000 Daltons, alternatively from 180,000 to 240,000 Daltons. Other parameters, such as melt flow rate or Vicat softening temperature, may be important when the HIPS of this disclosure is used in some molding or thermoforming processes. Such parameters may be adjusted or controlled, at least to some extent, according to known methods. For example, mineral oil may be added to the HIPS, if desired, to increase the melt-flow ratio for use in injection molding processes.

In an embodiment, the HIPS produced according to this disclosure displays a narrow elastomer particle size distribution. The HIPS elastomer particle size span may be narrowed by equal to or less than 30%, alternatively equal to or less than 20%, alternatively equal to or less than 10% when compared to otherwise identical polystyrene lacking a high-cis polybutadiene elastomer. The elastomer particle size distribution in the polystyrene matrix may range from 1 micron to 15 microns in size, alternatively from 2 microns to 9 microns in size, and alternatively from 2 microns to 8 microns in size. As is known to one of ordinary skill in the art, the particle size of the elastomer particles may be affected by the particular applied shear rate, heat, pressure, temperature or a combination of these factors, during the stage of inversion of the polymerization when PS becomes the continuous phase. The HIPS produced by this disclosure may be further characterized by elastomer particles having an average diameter (volume) in microns of from 0.5 microns to 15 microns, alternatively from 1.5 microns to 12.5 microns, or alternatively from 3 microns to 9 microns.

In an embodiment, the HIPS produced according to this disclosure displays a narrow elastomer particle size span when compared to an otherwise identical HIPS production lacking a high-cis polybutadiene elastomer. The elastomer particle size span of the HIPS of this disclosure may be from 1 to 2, alternatively from 1 to 1.8, alternatively from 1.2 to 1.5.

In an embodiment, HIPS with a desired morphology is formed through the use of a high reaction rate and a high level of initiator. Alternatively, HIPS with a desired morphology is formed through the use of a high reaction rate and high temperature. The HIPS of this disclosure may display a reduced incidence of mazes, thread and core-shells when compared to an otherwise identical composition lacking a HCP. Specifically, the HIPS of this disclosure may have equal to or less than 10% of the elastomer particles have a particle size of less than 1 micron, alternatively equal to less than 8%, alternatively equal to or less than 4%.

The HIPS produced by the disclosed methodologies may be useful for a range of applications including but not limited to; food packaging, office supplies, point-of-purchase signs and displays, housewares and consumer goods, building insulation and cosmetics packaging.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner.

### Example 1

In the following experiment, twelve batch polymerizations were carried out using the following temperature profile: 2 hours at 110° C., 1 hour at 130° C. and 1 hour at 150° C. Feed solutions contained 6 wt. % elastomer and 400 ppm of t-butylperoxy isopropyl carbonate (TBIC) in styrene monomer. The TBIC concentration is equivalent to 36 ppm active oxygen. The reactions were carried out in 500 ml resin kettles equipped with a stirrer operated at 230 to 250 rpms. The resin kettles are submersed in an oil bath at the temperatures indicated in the temperature profile. Samples were removed periodically and the percent solids were measured. Samples were collected at the end of the run and devolatilzed.

Table 2 shows the different elastomers used in the batch polymerization, their abbreviations are in parentheses.

TABLE 2

| | | | | Brookfield |
|---|---|---|---|---|
| | | | Solution | Solution |
| | | | viscosity/ | Viscosity cP |
| | | | Mooney | at 22° C. |
| Elastomer | Type | Structure | ML4 viscosity | 6% in styrene |
| DIENE 35 (D-35) | Low cis | linear | 2-4 | 145 |
| DIENE 55 (D-55) | Low cis | linear | 2-4 | 370 |
| DIENE 70 (D-70) | Low cis | linear | 2-4 | 1150 |
| 320 (F-320) | Low cis | branched | 0.4 | 760 |
| 8967** (L-8967) | High cis | very linear | 8-9 | 550 |
| 8969** (L-8969) | High cis | very linear | 8-9 | 315 |

**produced with neodymium catalysts, >95% cis

DIENE 35, DIENE 55, DIENE 70, and 320 are low cis polybutadiene elastomers commercially available from Firestone. The DIENE products each have a microstructure that is 11% vinyl, 38% cis and 51% trans. 8967 and 8969 are high cis polybutadiene elastomers commercially available from Lanxess Corporation with a greater than 95% cis content and less than 1% vinyl content. The elastomer structure is defined as linear based on a comparison of the Mooney viscosity to the solution viscosity. A ratio of solution viscosity/Mooney viscosity of 3 to 9 indicates less than 0.10 branches/molecule using a light scattering technique for determination. A ratio of solution viscosity/Mooney viscosity of 0.4 indicates 2 branches per molecule.

### Example 2

The elastomer particle size and molecular weights of the devolatized products from samples prepared in Example 1 were determined and are given in Table 3.

TABLE 3

| | Elastomer | | D [0.5] | | | |
|---|---|---|---|---|---|---|
| Batch # | Type | Span | microns | Mn (000) | Mw (000) | PI |
| 1 | D-35 | 16.54 | 0.66 | 146454 | 310773 | 2.1 |
| 2 | D-35 | 31.71 | 0.81 | 142054 | 306416 | 2.2 |
| 3 | D-55 | 2.03 | 1.2 | 142152 | 301789 | 2.1 |
| 4 | D-55 | 1.22 | 1.41 | 133560 | 288486 | 2.2 |
| 5 | D-70 | 1.42 | 2.12 | 124039 | 257370 | 2.1 |
| 6 | D-70 | 3.61 | 2.37 | 120974 | 254708 | 2.1 |
| 7 | F-320 | 2.34 | 2.69 | 133735 | 277263 | 2.1 |
| 8 | F-320 | 2.22 | 2.78 | 135950 | 292999 | 2.2 |
| 9 | L-8967 | 0.89 | 3 | 119351 | 271448 | 2.3 |
| 10 | L-8967 | 0.91 | 4.32 | 129670 | 283619 | 2.2 |
| 11 | L-8969 | 1.05 | 3.82 | 137610 | 291454 | 2.1 |
| 12 | L-8969 | 1.78 | 4.69 | 142858 | 304927 | 2.1 |

The span is a measure of the breadth of the particle size distribution and is calculated as follows: Span=Difference of Volume Average of 90% of the particles−Volume Average of 10% of the particles divided by the Volume Average particle size. The particle size distribution is given as the mean diameter in microns of the elastomer particle or D [0.5] microns. The number average molecular weight (Mₙ) is the common average of the molecular weights of the individual polymers calculated by measuring the molecular weight of n PS molecules, summing the weights, and dividing by n. The molecular weight that is reported is that of the polystyrene phase, since the polybutadiene is crosslinked it is not considered in the molecular weight determinations. The weight average molecular weight (Mw) of a HIPS is calculated according to equation 1:

$${M}_{w} = \frac{{\sum }_{i} {n}_{i} {M}_{i}^{2}}{{\sum }_{i} {n}_{i} {M}_{i}} \qquad ( 1 )$$

where nᵢ is the number of molecules of molecular weight Mᵢ. The molecular weight distribution (MWD) of the PS matrix of the HIPS composition may be characterized by the ratio of the weight average molecular weight to the number average molecular weight, which is also referred to as the polydispersity index (PI) or more simply as polydispersity.

The results show a narrow elastomer particle size distribution in batches 9-12 when a high-cis polybutadiene elastomer was used as indicated by the span. The span for HIPS produced with the high cis elastomers was less than 2. Furthermore, the average elastomer particle size increased to a range of 3-5 microns when a high-cis polybutadiene elastomer was employed.

### Example 3

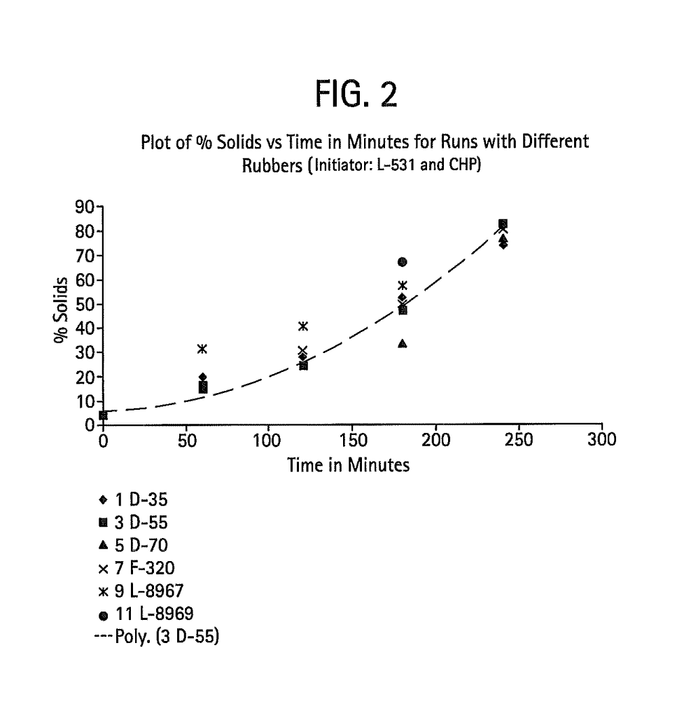

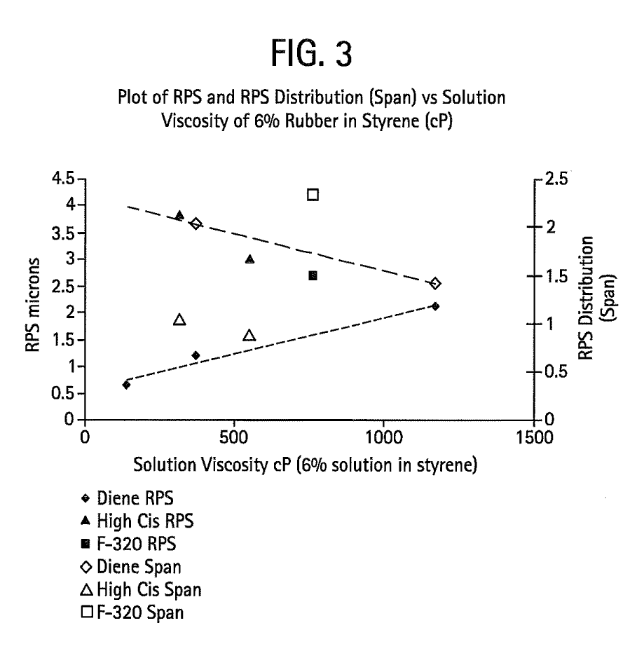

The extent of polystyrene conversion (PS conversion), the elastomer particle size, elastomer particle size distribution and morphologies of the samples described in Example 1 were further characterized in FIGS. 2 and 3.

FIG. 2 shows PS conversions, as measured by % solids, at different reaction times. The percent solids values were obtained by removing aliquots of the reaction solution (Ms) from the reactor and determining the weight of the sample after evaporating the solvent (Me) according to the following equation: % solids=100(Ms−Me)/Ms. The dotted line in FIG. 2 shows typical kinetics for PS polymerizations using Diene 55. HIPS produced with Diene elastomer (35, 55, and 70) and with Firestone 320 gave the same rate profiles, within experimental error. The high cis elastomers (Lanxess 8967 and 8969) gave higher conversion rates, which without being limited by any theory, are believed to be due to poor temperature control due to the highly viscous solutions in small glass reactors. Reactions with both high cis elastomers were terminated about one hour before those containing low cis elastomer due to the viscoelastic nature of the solutions, which gave pronounced rod-climbing properties. Rod climbing properties refer to a phenomenon known to occur in all viscoelastic materials termed the Weissenberg effect. The Weissenberg effect refers to the elastic behavior of the solution wherein the solutions creep up an agitator shaft to a particular extent at a given viscosity.

FIG. 3 is a plot showing the elastomer particle size (volume median in microns) and the span as a function of the viscosity of the elastomer used. Brookfield viscosities were determined on 6% elastomer solutions prepared by dissolving the elastomer in styrene monomer at room temperature and were used to compare the elastomers. It is well known that as the viscosity of the elastomer is increased, the elastomer particle size increases. This is shown for Diene 35, Diene 55 and Diene 70. The branched PB (Firestone 320) and the high cis elastomers (Lanxess 8967 and 8969) are shown to behave differently than the linear, low cis elastomers. High cis elastomers give much higher RPS values than those expected from an increase in viscosity alone. The slope of the RPS vs elastomer viscosity line depends on conditions that are related to particle formation; namely, bulk viscosity and shear rate at time of inversion and the level of grafting.

FIG. 3 also shows how the span varies as a function of the viscosity of the elastomer solutions. The measurements of RPS and Span are done using a standard laser light scattering technique. Such techniques for determination of RPS and Span are known to one of ordinary skill in the art and include for example use of a MASTERSIZER 2000 integrated system for particle sizing commercially available from Malvern Instruments. For the low cis, linear DIENE elastomers, the distribution narrows as the viscosity of the elastomer increases. For the high cis elastomers, very low span values ranging from 1 to 2 are obtained. This is an unexpected and very important result, since many physical properties of elastomer-toughened plastics are dependent on the elastomer particle size distribution.

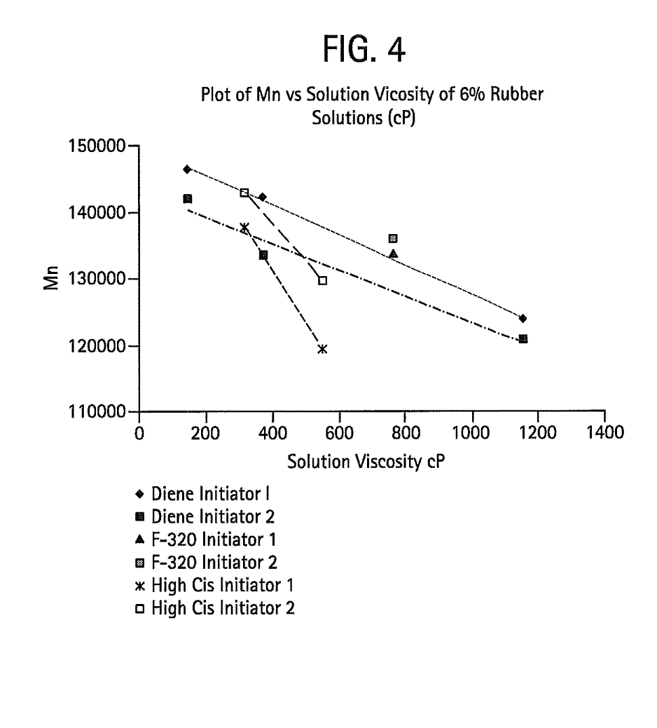

FIG. 4 is a plot of PS molecular weight (Mn) versus viscosity of the elastomer solution for samples similar to those described in Example 1 with the exception of the use of differing initiator packages. As indicated, samples contained either Initiator package 1 or 2. Initiator package 1 contained a mixture of 200 ppm LUPEROX 531 M80 and 75 ppm CU90 while initiator 2 contained a mixture of 150 ppm LUPEROX 531 M80, 75 ppm CU90 and 50 ppm XPS. LUPEROX 531 M80 is 1,1-Di(t-amylperoxy)cyclohexane, CU90 is cumene hydroperoxide and XPS is a peroxide initiator all of which are commercially available from Arkema. The initiators used in this experiment had a range of one-hour half-life temperatures (T_{1/2}) with the LUPEROX 531 M80 initiator having a T_{1/2}=117° C., the XPS initiator having a T_{1/2}=105° C. and the CU90 initiator having a T_{1/2}=170° C. The longer T_{1/2} of the Cu90 initiator indicates that it would be present in the reaction mixture for a longer time period than either the XPS or L531. The data demonstrate that as the viscosity increases for the linear, low cis elastomers, the molecular weight of the PS phase decreases. Without being limited by any theory, this decrease could be due to chain transfer and/or to higher rates due to the poor temperature control at the high viscosities and the viscoelastic nature of the solutions. The change in Mn for a given viscosity range is nearly three times that for the high cis elastomers when compared to the medium cis elastomers. The decrease in Mn, without being limited by any theory, is believed to be due to higher rates.

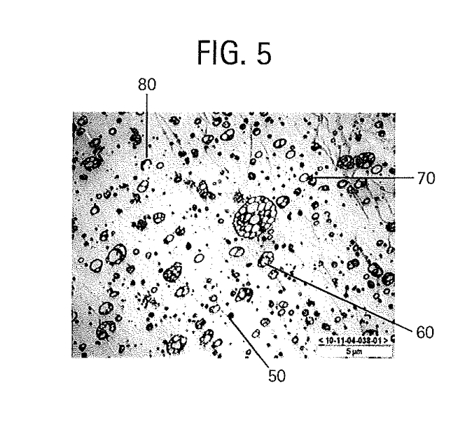

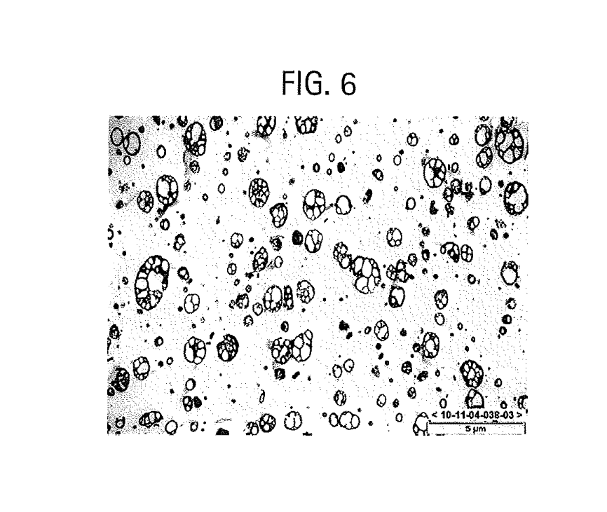

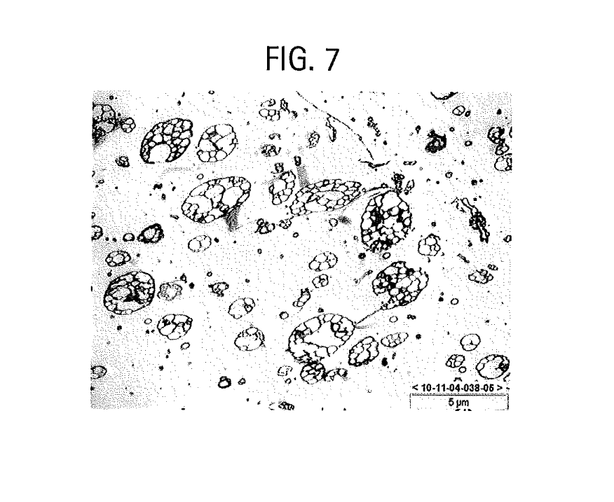

FIGS. 5 through 10 present the morphologies of the HIPS samples obtained via TEM techniques. FIGS. 5-7 present the TEMs of HIPS produced with linear, low cis elastomers DIENE 35, DIENE 55 and, DIENE 70 respectively. According to Firestone, these elastomers have the same microstructure and differ only in their molecular weights, as shown by the Brookfield viscosities of 6% solutions in styrene. At the conditions selected for the polymerization, mixed morphologies, which are characteristic of the use of high shear and high initiator levels, are obtained. Specifically, referring to FIG. 5 particles of the type indicated by 50 are polybutadiene particles, which show as dark circles in the TEM. Particles of the type indicated by 60 are irregularly shaped complex particles having several occlusions of polystyrene (clear) with a polybutadiene membrane (dark). The morphology of particle 60 is best characterized as a salami morphology. Particles of the type indicated by 70 are examples of a polystyrene particle with a core-shell morphology. Specifically, such particles have a clear polystyrene core and a dark polybutadiene membrane or shell surrounding the polystyrene. Particles of the type indicated by 80 are an example of a broken particle having a portion of the polybutadiene membrane intact. As the viscosity of the elastomer is increased, the particle size increases, the level of core-shell and thread structures decrease; however, particle breakage is still evident, as seen by the presence of particles of the type denoted 80.

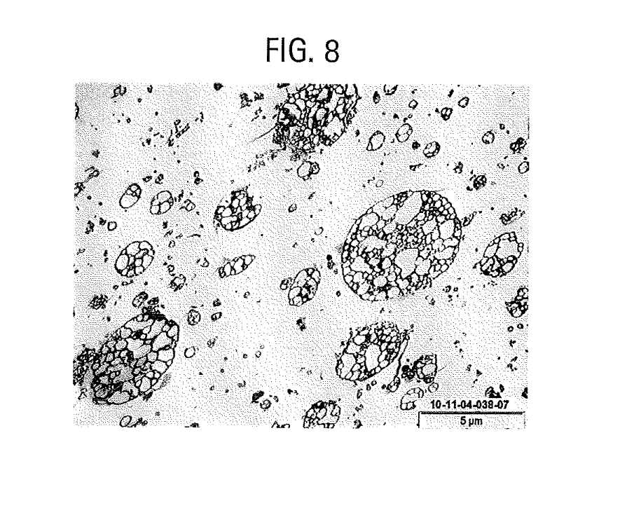

FIG. 8 shows the morphology of HIPS obtained with Firestone's branched low cis polybutadiene elastomer (F-320). The TEM shows an increased particle size with this elastomer; however, the morphology produced is still a mixed morphology characterized by core-shell and broken particles. FIGS. 5 through 8 show the prevalence of small particles in the TEM having broken membranes and large numbers of particles with the core-shell morphology.

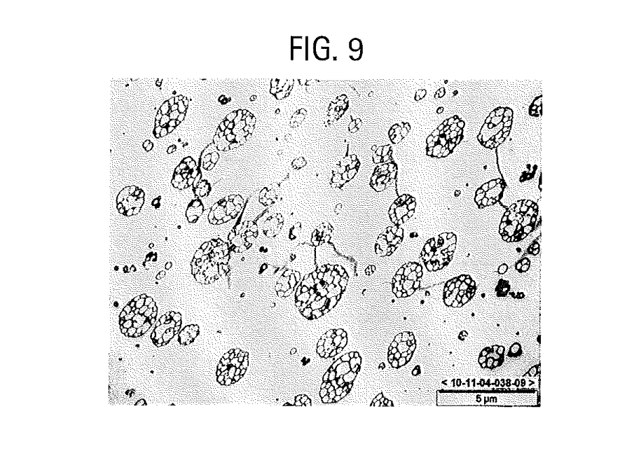

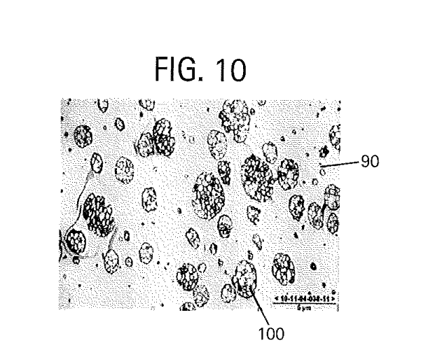

FIG. 9 and FIG. 10 show the morphologies obtained with the linear, high cis elastomers, Lanxess 8967 and 8969 respectively. Both materials show morphologies with less core-shell and broken particles. As shown earlier, the elastomer particle size (also termed the rubber particle size RPS) is larger and the RPS distribution is much narrower for these materials. Specifically referring to FIG. 10, the majority of the particles are of the type labeled 90 and 100 having a particle diameter of greater than 3 microns with intact membranes of polybutadiene surrounding polystyrene to give a salami morphology. There are fewer particles of the type indicated by 90 that are smaller in size and have a core-shell morphology.

The results of the transmission electron microscopy (TEM) demonstrate HIPS produced with low-cis polybutadiene elastomers display significant levels of core-shell and thread morphologies, which affect the elastomer particle size volume average at conditions that lead to high reaction rates.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from 1 to 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

1-20. (canceled)

21. A method of preparing a high impact polystyrene (HIPS) comprising:
contacting styrene monomer;
from 1 wt. % to 15 wt. % of a high cis polybutadiene elastomer having a Solution viscosity/Mooney ML4 viscosity greater than 4 and wherein the elastomer is produced using a neodymium based catalyst and having a greater than 90% cis content; and an initiator under high shear within a reaction zone, wherein the high shear is from 50 s⁻¹ to 500 s⁻¹, to thereby produce HIPS having an average elastomer particle size in a polystyrene matrix of from 0.5 microns to 15 microns.

22. The method of claim 21 wherein a temperature range for the HIPS polymerization is from 100° C. to 180° C.

23. The method of claim 21 wherein the polybutadiene elastomer has a vinyl content of less than 5%.

24. The method of claim 21 wherein the elastomer has a linear structure having 2 branches per molecule or less.

25. The method of claim 21 further comprising preparing the high impact polystyrene at a high production rate, wherein the production rate is greater than 8% polystyrene/hr (PS/hr) at styrene concentrations of from 55 parts per hundred to 100 parts per hundred in a reaction mixture.

26. The method of claim 25 wherein the HIPS polymerization reaction is carried out in a reactor system employing a first and a second polymerization reactor that are continuously stirred tank reactors (CSTR), wherein the first CSTR is operated in a temperature range of from 110° C. to 135° C., and wherein the second CSTR is operated in a range of from 135° C. to 165° C.

27. The method of claim 21 wherein the initiator is selected from diacyl peroxides, peroxydicarbonates, monoperoxycarbonates, peroxyketals, peroxyesters, dialkyl peroxides, hydroperoxides, and combinations thereof.

28. A high-impact polystyrene (HIPS), comprising:
styrene monomer;
a high cis polybutadiene elastomer having a Solution viscosity/Mooney ML4 viscosity greater than 3 and wherein the elastomer is produced using a neodymium based catalyst and having a vinyl content of less than 5% present in an amount of from 1 wt. % to 15 wt. %;
an initiator;
wherein the HIPS has an elastomer particle size distribution in a polystyrene matrix of from 0.5 microns to 15 microns; and
wherein the elastomer particle size span is narrowed by equal to or less than 30% when compared to an otherwise identical polystyrene lacking a high-cis polybutadiene elastomer.

29. The polystyrene of claim 28 wherein the polybutadiene elastomer has a greater than 90% cis content.

30. The polystyrene of claim 28 wherein the elastomer particles have an average diameter (volume) of from 0.5 microns to 15 microns.

31. The polystyrene of claim 28 wherein equal to or less than 10% of the elastomer particles have a particle size of less than 1 micron.

32. The polystyrene of claim 28 wherein the average elastomer particle size is greater than an otherwise identical composition lacking a high cis polybutadiene elastomer having a greater than 90% cis content.

33. The polystyrene of claim 28 wherein the average diameter in microns of the elastomer particles is equal to or greater than 3.

34. The polystyrene of claim 28 wherein the elastomer has less than 0.10 branches/molecule using a light scattering determination.

35. A method of preparing a high impact polystyrene (HIPS) comprising contacting styrene monomer, a high cis polybutadiene elastomer, and an initiator under extreme reaction conditions within a reaction zone, wherein the extreme reaction conditions comprise a shear of from 50 s⁻¹ to 500 s⁻¹ and a production rate of greater than 10% polystyrene/hour for a styrene concentration of from 55 parts per hundred to 100 parts per hundred styrene monomer, to thereby produce HIPS with a polydispersity (PI) of from 2.1 to 2.3, wherein the high cis polybutadiene elastomer has a Solution viscosity/Mooney ML4 viscosity greater than 3 and wherein the elastomer is produced using a neodymium based catalyst.

36. The method of claim 35 wherein the high cis polybutadiene has a greater than 90% cis content.

37. The method of claim 35 wherein a reaction mixture for a production of HIPS comprises from 75% to 99% styrene, from 1% to 15% of the high cis polybutadiene, and from 0.001% to 0.2% initiator.

38. The method of claim 21, wherein an elastomer particle size span is narrowed by equal to or less than 30% when compared to an otherwise identical polystyrene lacking a high cis polybutadiene elastomer with a greater than 90% cis content.

39. The method of claim 21, wherein the Solution viscosity/Mooney Ml4 viscosity of from 3 to 9.

40. The method of claim 21, wherein the neodymium based catalyst is an alkyl metal catalyst.

41. The method of claim 40, wherein the catalyst is a Ziegler-Natta catalyst.

42. The method of claim 21, wherein the elastomer has a solution viscosity of from 250 to 600 cP at 22° C. and 6 wt. % in styrene.

43. The method of claim 21, wherein the elastomer has Mooney viscosity of 35 to 70 MU.
